(19) United States
(12) Patent Application Publication
(10) Pub. No.: US 2022/0009839 A1
(43) Pub. Date: Jan. 13, 2022

(54) CARBON FOAM, SYSTEMS AND METHODS FOR FORMING THE SAME

(71) Applicant: CARBON HOLDINGS INTELLECTUAL PROPERTIES, LLC, Sheridan, WY (US)

(72) Inventors: Christopher L. Yurchick, McDonald, PA (US); Charles Agee Atkins, Sheridan, WY (US)

(21) Appl. No.: 17/374,926

(22) Filed: Jul. 13, 2021

Related U.S. Application Data
(60) Provisional application No. 63/051,234, filed on Jul. 13, 2020.

(51) Int. Cl. C04B 35/83; C01B 32/05; C01B 32/21; C04B 35/64

(52) U.S. Cl. CPC C04B 35/83; C01B 32/05; C01B 32/21; C04B 2235/656; C04B 2235/5248; C04B 2235/425; C04B 35/64

(57) ABSTRACT

Embodiments discloses herein relate to low-cost methods of producing a carbon foam through blending at least one carbon source with at least one solvent to form a mixture and heating the mixture at atmospheric pressure and in a non-oxidizing atmosphere to form a carbon foam. Given that the carbon foam is produced at atmospheric pressure, the methods disclosed herein may include a continuous process.

### CROSS REFERENCE TO

This application is a non-provisional patent application of, and claims priority to U.S. Provisional Patent Application No. 63/051,234, filed 13 Jul. 2021, entitled “COAL FOAM, SYSTEMS AND METHODS FOR FORMING THE SAME” the disclosure of which is incorporated by reference in its entirety.

### BACKGROUND

Foams are porous solids. Carbon foams have been produced for over twenty years and possess numerous beneficial characteristics. These characteristics can include lightweight, high compression strength, thermal insulation, fire resistant, electrically conductive, mold resistant, and thermal conductivity when using anisotropic or mesophase pitch as a foam precursor.

A method for forming carbon foams includes using n-methyl-2-pyrrolidone (“NMP”) soluble extracts from coal and heating the extracts to 500° C. at an elevated pressure of 500 psig to produce the carbon foams. In this conventional method, the extracts devolatilize and the remainder of the carbon crosslinks to form a firm porous solid. The expelled volatiles create bubbles in the molten liquid extract. The external pressure prevents the rapid escape of the volatiles so that the volatiles form bubbles within the molten extract. As the extract further crosslinks, the volatiles escape and a porous solid is produced.

Another method for forming carbon forms includes using carbon-based foams, such as polyacrlyic foams. These carbon-based foams are pyrolyzed to pure carbon or near pure carbon. The carbon skeleton of the foam remains intact and a carbon foam is produced.

Another method for forming carbon foams includes blending coal tar pitch or other pitches with ground coal. This blend is then heated to 500° C. at a pressure of 500 psig. Heating the blend causes the pitch to devolatilize. As the pitch devolatilizes, the volatiles are thought to be a flux, which promotes devolatilzation and crosslinking within the blend, which produces a carbon foam.

Another method for forming carbon foams has only been tested at laboratory scales. This method includes grinding coal or pitch is ground into a powder and placing the powder in a mold. In an embodiment, the method includes preparing a pitch with the proper volatile percent, grinding the pitch into a powder, and placing the powder into a mold. In such an embodiment, a green carbon foam is formed by heating the powdered pitch at specific ramp rates to sinter the pitch particles together and create the carbon foam. In another embodiment, the method includes mixing ground coal or pitch with a flux agent. In such an embodiment, the mixture is subjected to microwave radiation where the flux agent heats the coal or pitch causing the release of volatiles and sintering the particles together into a carbon foam.

Carbon foams produced using previously known methods may be costly to develop due to high pressures required while heating the pitch or other precursor to form carbon foam. As such, manufacturers and users of carbon foam continue to seek new and improved methods of forming carbon foam.

### SUMMARY

Embodiments discloses herein relate to low-cost methods of producing a carbon foam through a partial solvent extraction process and sintering process, traditional foaming, or a combination process carried out at atmospheric pressure. Given that the carbon foam (e.g., a green carbon foam) is produced at atmospheric pressure, the methods disclosed herein may include a continuous process.

In some embodiments, a method to form a carbon foam can include providing at least one carbon source. The carbon source can include a volatile portion. The method can further include blending the at least one carbon source with at least one solvent to form a mixture. The method can also include heating the mixture at atmospheric pressure to form the carbon foam. In some embodiments, the carbon foam precursor is heated in a non-oxidizing atmosphere.

In some embodiments, the method can further include a partial solvent extraction. The partial solvent extraction can include transferring the carbon foam precursor to a container and heating the mixture disposed within the container to an intermediate temperature at atmospheric pressure in a non-oxidizing atmosphere. In some embodiments, the extracted volatiles from the carbon source can be separated from the solvent and further processed into various carbon materials. The method can further include calcinating the carbon foam, in some embodiments. Calcinating the carbon foam can include heating the carbon foam in a non-oxidizing atmosphere to a temperature from about 800° C. to about 1400° C. The method can further include graphitization of the carbon foam. Graphitizing the carbon foam can include heating the carbon foam in a non-oxidizing atmosphere to a temperature from about 2000° C. to about 2600° C.

In some embodiments, the carbon source includes at least one of a bituminous coal, sub-bituminous coal, a pitch derived from sub-bituminous coal, a lignite coal, a pitch derived from lignite coal, coal tar, recycled green foam, and a green coke. Providing at least one carbon source can include grinding the carbon source to an average particle size of between about 1 cm to about 50 nm. In some embodiments, grinding the carbon source can include producing a bimodal particle size including a first average particle size and a second average particle size. The second average particle size can be different from the first average particle size. In some embodiments, grinding the carbon source can include producing a bimodal particle size having a first carbon source and a second carbon source. The second carbon source can include an average particle size that is different from the first carbon source. In some embodiments, the at least one solvent can include a polar solvent, a non-polar solvent, an organic solvent, an inorganic solvent, a supercritical solvent, a critical solvent, a subcritical solvent, or a combination thereof.

In some embodiments, a method to form a composite carbon foam can include producing a first carbon foam precursor through a partial solvent extraction, and grinding the first carbon foam precursor into a powder. The powder can include an average particle size of about 50 nm or greater. The method can further include adding one or more carbon fibers or carbon fiber tows to the first carbon foam precursor and heating the first carbon foam precursor and the at atmospheric pressure to form a composite carbon foam.

In some embodiments, adding one or more carbon fibers or carbon fiber tows to the first carbon foam precursor includes drawing the one or more carbon fibers across a surface of the carbon foam precursor and then adding an additional carbon foam precursor to incorporate the carbon fiber or carbon tows within the composite carbon foam. In some embodiments, the additional carbon foam precursor includes a second carbon foam precursor, wherein the second carbon foam precursor is different than the first carbon foam precursor, such that the composite carbon foam includes physical characteristics that interface at the carbon fiber or carbon fiber tow.

In some embodiments, the method can further include calcinating the composite carbon foam. Calcinating the composite carbon foam can include heating the composite carbon foam to a temperature from about 800° C. to about 1400° C. In some embodiments, the method can further include graphitizing the composite carbon foam. Graphitizing the composite carbon foam includes heating the composite carbon foam to a temperature from about 2000° C. to about 2600° C. In some embodiments, the first carbon foam precursor can be heated in a non-oxidizing atmosphere.

In some embodiments, a composite carbon foam can include a carbon foam disposed within a graphene, a graphene oxide, or graphite outer layer. In some embodiments, the graphene, graphene oxide, or graphite outer layer can include a thickness about 10 nm or greater. In some embodiments, the characteristics of the outer layer may be controlled by the type of material in an outer layer disposal process environment. In some embodiments, the carbon foam can include a carbon fiber or carbon fiber tow incorporated within the solid porous carbon foam. In some embodiments, the protective coating can be formed by applying a volatile rich component to an interior surface of a container holding a precursor to the carbon foam, manipulating the volatile content of the precursor to the carbon foam during the solvent extraction processor, or a combination thereof. The composite carbon can also include highly aligned crystallites in the ligaments. The embodiments disclosed herein also include carbon foams formed using any of the above methods and systems for performing any of the above methods.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a flow chart of a method to form carbon foam, according to an embodiment.

FIG. 2 is a schematic illustration of a system that performs the method illustrated in FIG. 1, according to an embodiment.

FIG. 3 is a flow chart of a method to form a composite carbon foam, according to an embodiment.

### DETAILED DESCRIPTION

Embodiments discloses herein relate to low-cost methods of producing a carbon foam through a partial solvent extraction process and sintering process, traditional foaming process, or a combination is carried out at atmospheric pressure. Given that the carbon foam (e.g., a green carbon foam) is produced at atmospheric pressure, the methods disclosed herein may include a continuous process. In some embodiments, the methods to produce carbon foam may be a batch or semi-batch process. In an example, the methods disclosed herein include the synthesis of carbon foam where the characteristics of the input carbon material are controlled by the type of material in an outer layer disposal process environment through a partial solvent extraction. In an example, the methods disclosed herein include the generation of graphene, graphene oxide, or graphite protective layer on the surface of the carbon materials simultaneously with the production of the carbon foams. In an example, the methods disclosed herein includes increasing carbon foam strength through the addition of carbon fiber filaments or tows into the carbon foam. In an example, the methods disclosed herein include the product of a composite carbon foam through a layered input approach. The embodiments disclosed herein also include carbon foams formed using any of the above methods and systems for performing any of the above methods.

An example method of forming the carbon foam includes producing a sintered carbon foam, a traditional carbon foam, or a combination of the two from a carbon source (e.g., coal or coal derived pitch). In such an example, the carbon source is provided within a container. In some embodiments, the carbon source includes a volatile portion. The carbon source can include at least one of a coal, a coal-derived pitch, a coal tar, a graphite, a petroleum, a petroleum product, a petroleum-derived pitch, a naphthalene-derived pitch, a green carbon foam, a green coke, or a combination thereof. The volatile portion of the carbon source can be reduced by a partial solvent extraction. The partial extraction includes at least one solvent to form a carbon foam precursor. The carbon foam precursor can be heated under atmospheric pressure to form carbon foam. In some embodiments, the carbon foam precursor can be heated in a non-oxidizing atmosphere. The partial solvent extraction reduces the volatile content of the coal and allows the fixed carbon and remaining volatiles to combine into a continuous carbon foam. The density, quality, and other characteristics of the foam can be controlled by at least the particle size of the input coal, the chemical composition of the remaining volatiles in the precursor material, and the ratio of fixed carbon to volatiles remaining after the solvent extraction.

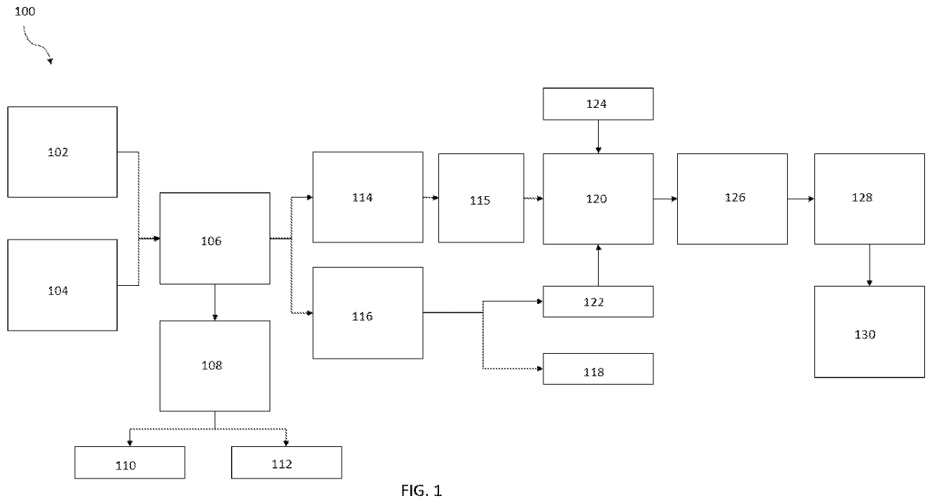

FIG. 1 is a flow chart of a method 100 to form carbon foam, according to an embodiment. The method 100 may include one or more operations, functions, components, or actions as illustrated by one or more of acts and/or components 102-120. It is noted that the acts 102-120 are for illustrative purposes. In some examples, at least one of the acts may be performed in a different order. In some examples, at least one of the acts may be eliminated. In some examples, at least one of the acts may be divided into multiple acts, modified, or supplemented. In some examples, at least some of the acts may be combined into a single act. In some examples, the method 100 may include one or more additional acts, such as graphitizing the carbon foam.

The method 100 may include act 102. Act 102 includes providing at least one carbon source. In some embodiments, the carbon source may be provided within a container. In some embodiments, the carbon source may be container can include a vent mold, such that the carbon foam, when formed, includes a predetermined shape. The container (e.g., vessel or mold) can be selected for the desired shape of the carbon foam to be produced. The carbon source can include a volatile portion. In an embodiment, as illustrated, act 102 includes providing coal. The coal may include bituminous coal. It is currently believed that bituminous coal is the rank of coal that is the best candidate to produce the highest quality carbon foam (e.g., coal having a desired density and high strength). Other coals that may be provided during act 102 includes sub-bituminous coal, lignite coal, or any other grade of coal. In an embodiment, act 102 may include providing one or more coal-derived materials. The one or more coal-derived materials may include coal-derived pitch, such as coal derived pitch formed from bituminous, sub-bituminous, or lignite coal. Other examples of coal-derived materials includes coal tar, recycled green carbon foam, various cokes, or any other coal-derived material. In an embodiment, act 102 may include providing petroleum derived pitch or petroleum products. In an embodiment, act 102 may include providing other carbon sources depending upon the specific processing conditions, such as graphite and petroleum. In an embodiment, act 102 may include providing a combination of any of the carbon sources disclosed herein at various ratios, such as a mixture of coal and coal-derived pitch, or a mixture of two coal types.

Along with act 102, the method may include act 104. Act 104 includes providing at least one solvent. In an embodiment, the solvent may include at least one polar solvent, at least one non-polar solvent, at least one organic solvent, at least one inorganic solvent, at least one supercritical solvent, at least one critical solvent, at least one sub-critical solvent, or combinations thereof (e.g., co-solvents). In an embodiment, the solvent may include any liquid hydrocarbon with the ability to at least partially dissolve coal, coal extracts, or other carbon sources. Specific examples of some of the solvents that may be provided in act 106 includes quinolone, tetralin, NMP, tetrahydrofuran, toluene, coal liquids, coal tar distillate, kerosene, other petroleum distillates, crude oil, decant oil, or combinations thereof.

After acts 102 and 104, the method 100 may include act 106. Act 106 includes blending the carbon source provided in act 102 with the at least one solvent provided in act 104 to form a mixture. During the blending of act 106, the carbon source and container is heated at atmospheric pressure in a non-oxidizing atmosphere.

Act 106 includes transferring the mixture formed to a container (e.g., vessel or mold) selected for the desired shape of the carbon foam to be produced. A partial solvent extraction occurs on the coal or other feed materials as specific volatiles are removed from the coal based on the solvents used. The remaining volatiles in the fixed carbon structure are available to sinter the coal particles together, perform traditional carbon foaming at atmospheric pressure, or a combination of the two to form the solid carbon foam. The carbon foam precursor material is then transferred to the container and heated from room temperature up to an intermediate temperature at atmospheric pressure in a non-oxidizing atmosphere. In particular, act 106 may cause the volatiles in the mixture to form bubbles in the mixture and the carbon source may start bonding or sticking together to form a green carbon foam.

The intermediate temperature may be about 300° C. or greater, about 350° C. or greater, about 400° C. or greater, about 450° C. or greater, about 500° C. or greater, or in ranges of about 300° C. to about 400° C., about 350° C. to about 450° C., or about 400° C. to about 500° C. The container may be heated at a selected rate. The at least one rate may be about 0.25° C. per minute (“° C./min”) or greater, about 0.5° C./min or greater, about 1° C./min or greater, about 1.5° C./min or greater, about 2° C./min or greater, about 3° C./min or greater, about 4° C./min or greater, about 5° C./min or greater, about 7.5° C./min or greater, about 10° C./min or greater, about 15° C./min or greater, about 20° C./min or greater, about 30° C./min or greater, about 40° C./min or greater, about 50° C./min or in ranges of about 0.25° C./min to about 1° C./min, about 0.5° C./min to about 1.5° C./min, about 1° C./min to about 2° C./min, about 1.5° C./min to about 3° C./min, about 2° C./min to about 4° C./min, about 3° C./min to about 5° C./min, about 4° C./min to about 7.5° C./min, about 5° C./min to about 10° C./min, about 7.5° C./min to about 15° C./min, about 10° C./min to about 20° C./min, about 15° C./min to about 30° C./min, about 20° C./min to about 40° C./min, about 30° C./min to about 50° C./min. The rate may be selected based on the composition of the carbon source, the solvent used, the amount of the carbon source in the mixture, the desired porosity of the carbon foam, the insulating properties of the green carbon foam, or the rate that allows a consistent heat gradient in the mixture, etc.

In an embodiment, act 106 may include heating the container at a plurality of rates. For example, the container may be heated at a first rate to a first temperature followed by heating the container at a second rate to a second temperature. Generally, the first rate is greater than the second rate since causing the mixture to foam may increase the thermal insulating properties thereof thereby requiring a lower rate to maintain a consistent heat gradient in the mixture. In other words, the decrease in heating rate is attributed to creating a consistent heat gradient and therefore more consistent and stronger solid carbon foam. In a particular non-limiting example, the container may be heated at the first rate (e.g., about 2° C./min to about 50° C./min) until the container reaches a temperature of about 200° C. to about 350° C., such as about 250° C. to about 300° C. Then, the container is heated at the second rate (e.g., about 0.25° C./min to about 15° C./min) until the container reaches the intermediate temperature.

Act 106 includes increasing the temperature of the container from the intermediate temperature to a final temperature to drive off additional volatiles which will cross-linking the fixed carbon skeleton in creating a stronger carbon foam. The final temperature may be about 400° C. or greater, about 450° C. or greater, about 500° C. or greater, about 550° C. or greater, about 600° C. or greater, about 700° C. or greater, or in ranges of about 400° C. to about 500° C., about 450° C. to about 550° C., about 500° C. to about 600° C., or about 550° C. to about 700° C. The rate at which the container is heated from the intermediate temperature to the final temperature may be about 0.25° C. per minute (“° C./min”) or greater, about 0.5° C./min or greater, about 1° C./min or greater, about 1.5° C./min or greater, about 2° C./min or greater, about 3° C./min or greater, about 4° C./min or greater, about 5° C./min or greater, about 7.5° C./min or greater, about 10° C./min or greater, about 15° C./min or greater, about 20° C./min or greater, about 30° C./min or greater, about 40° C./min or greater, about 50° C./min or in ranges of about 0.25° C./min to about 1° C./min, about 0.5° C./min to about 1.5° C./min, about 1° C./min to about 2° C./min, about 1.5° C./min to about 3° C./min, about 2° C./min to about 4° C./min, about 3° C./min to about 5° C./min, about 4° C./min to about 7.5° C./min, about 5° C./min to about 10° C./min, about 7.5° C./min to about 15° C./min, about 10° C./min to about 20° C./min, about 15° C./min to about 30° C./min, about 20° C./min to about 40° C./min, about 30° C./min to about 50° C./min. In an embodiment, the rate at which the container is heated from the intermediate temperature to the final temperature may be less than the rate at which the container is heated from room temperature to the intermediate temperature (e.g., less than the first rate or the second rate) due to maintaining an even temperature gradient as a carbon foam becomes more insulating as it forms. It is noted that act 106 may be performed at atmospheric pressure and/or in a non-oxidizing atmosphere.

In particular, act 106 may cause the volatiles from within the carbon source to be extracted from the carbon source. In some embodiments, the volatiles can start bonding or sticking together to form a green carbon foam. During this time, a partial solvent extraction occurs as volatiles are removed from the coal and then vaporized. The remaining volatiles are available to sinter the coal particles together and form a carbon foam precursor. As used herein, atmospheric pressure is generally −1 psig to about 1 psig to account for variations in atmospheric pressure caused by variations in elevation and weather. However, it is noted that atmospheric pressure may also include pressures ranging from −10 psig (e.g., 10 psiv) to about 15 psig. As used herein, a non-oxidizing atmosphere is an atmosphere that includes less oxidizing (e.g., includes no oxygen) than the atmosphere. Examples of a non-oxidizing atmosphere includes an argon atmosphere, a nitrogen atmosphere, an argon/nitrogen atmosphere, or any other suitable non-oxidizing atmosphere.

During act 106, the solvent will be agitated as the carbon source is added. In an embodiment, the residence time is sufficient to create a homogeneous mixture between the carbon source and the solvent. The residence time may be about 1 second or greater, about 15 seconds or greater, about 30 seconds or greater, about 45 seconds or greater, about 1 minute or greater, about 5 minutes or greater, about 15 minutes or greater, about 30 minutes or greater, about 45 minutes or greater, about 1 hour or greater, about 2 hours or greater, about 6 hours or greater, about 12 hours or greater, or in ranges of about 1 second to about 30 seconds, about 15 seconds to about 45 seconds, about 30 seconds to about 1 minute, about 45 seconds to about 5 minutes, about 1 minute to about 15 minutes, about 5 minutes to about 30 minutes, about 15 minutes to about 45 minutes, about 30 minutes to about 1 hour, about 45 minutes to about 2 hours, about 1 hour to about 6 hours, or about 2 hours to about 12 hours. The residence time may be selected based on the method used to agitate the carbon source and the solvent (e.g., mechanical mixing, the size of the mechanical mixer, ultrasound agitation, etc.), the weight percent of the carbon source in the mixture, and the wettability of the solvent in the carbon source. In an embodiment, the residence time is not sufficient to form a homogeneous mixture, such as when it is desired for the coal particles to be inconsistently wetted with the solvent for the purposes of the green foaming process.

Generally, the carbon source forms more of the mixture, by weight, than the solvent. For example, the carbon source may form 51 weight percent (“wt. %”) or greater of the mixture, such as about 55 wt. % or greater, about 60 wt. % or greater, about 65 wt. % or greater, about 70 wt. % or greater, about 75 wt. % or greater, about 80 wt. % or greater, about 85 wt. % or greater, about 90 wt. % or greater, about 95 wt. % or greater, or in ranges of about 51 wt. % to about 60 wt. %, about 55 wt. % to about 65 wt. %, about 60 wt. % to about 70 wt. %, about 65 wt. % to about 75 wt. %, about 70 wt. % to about 80 wt. %, about 75 wt. % to about 85 wt. %, about 80 wt. % to about 90 wt. %, or about 85 wt. % to about 95 wt. %. In some embodiments, the carbon source may form less than 50 wt. % of the mixture. The solvent should coat the surface of the carbon source and create a maximum surface area of contact for efficient partial solvent extraction of the volatiles in the mixture. Different carbon sources will have different solvent blends and form different weight percentage of the mixture depending upon the desired properties of the end products. Additionally, the same carbon source may also have various solvents or solvent blends and employs to produce various desired and products. In an example, the weight percent of the carbon source may depend on the surface area of the carbon source since increasing the surface area of the carbon source may require more solvent to coat the carbon source. In an example, the weight percent of the carbon source may be selected based on the desired porosity of the carbon foam since increasing the amount of solvent in the mixture may increase the porosity. In an example, the weight percent of the carbon source in the mixture may be selected based on the composition of the carbon source. For instance, coal-derived pitch and petroleum-derived pitches may include volatile compounds therein, thereby reducing the amount of added solvent that is required to form a desired carbon foam.

During and/or after act 106, the method 100 can include act 108 of recovering solvent and coal liquid, in some embodiments. Act 108 includes recovering the solvent and liquid (e.g., coal liquid) generated during act 106. For example, the mixture and the formation of the green carbon foam may generate vapors as the temperature is increased. These vapors are the volatiles released from the carbon source as well as the solvent. As these volatiles are driven off, they can be collected or simply sent to a thermal oxidizer or furnace to be combusted. Depending upon the value of the solvent used, it can be separated and recycled back to the process for additional use as shown by act 110, unless incorporated into the product. The liquids can be collected and used in other carbon materials processes or sold as the feedstock to produce additional chemicals, as shown in act 112. Based on the economics, the solvent can be chosen to produce particular properties or characteristics in the recovered liquids to add value to the products.

After act 106, the method 100 can include act 114 of forming a carbon foam precursor. Generally, the properties of carbon foam mainly depend on the foaming precursor and the foam cell structure. Coal and coal extracts are the suitable foaming precursors. They generate a strong, isotropic foam suitable for structural applications and energy absorption.

The method 100 may also include act 115 of grinding and sizing the carbon precursor. For example, act 115 may include grinding the carbon precursor until the solid particles of the carbon precursor exhibit an average particle size that is about 50 nm or greater, about 100 nm or greater, about 250 nm or greater, about 500 nm or greater, about 750 nm or greater, about 1 μm or greater, about 5μm or greater, about 10 μm or greater, about 25 μm or greater, about 50 μm or greater, about 100 μm or greater, about 250 μm or greater, about 500 μm or greater, about 750 μm or greater, about 1 mm or greater, about 2.5 mm or greater, about 5 mm or greater, about 1 cm or greater, about 7.5 mm or less, about 5 mm or less, about 2.5 mm or less, about 1 mm or less, about 750 μm or less, about 500 μm or less, about 250 μm or less, about 100 μm or less, about 75 μm or less, about 50 μm or less, about 25 μm or less, about 10 μm or less, about 5μm or less, about 1 μm or less, about 750 nm or less, about 500 nm or less, or in ranges of about 50 nm to about 250 nm, about 100 nm to about 500 nm, about 250 nm to about 750 nm, about 500 nm to about 1 μm, about 750 nm to about 2.5 μm, about 1 μm to about 5 μm, about 2.5 μm to about 7.5 μm, about 5 μm to about 10 μm, about 7.5 μm to about 25 μm, about 10 μm to about 50 μm, about 25 μm to about 75 μm, about 50 μm to about 100 μm, about 75 μm to about 250 μm, about 100 μm to about 500 μm, about 250 μm to about 750 μm, about 500 μm to about 1 mm, about 750 μm to about 2.5 mm, about 1 mm to about 5 mm, about 2.5 mm to about 7.5 mm, or about 5 mm to about 1 cm. It is noted that the average particle size of the carbon precursor may be reduced to any of the average particle sizes disclosed herein using techniques other than grinding, such as using a crusher or a homogenizing equipment. After reducing the particle size of the carbon precursor, the carbon precursor may be sized (e.g., sieved) to at least one of reduce the average particle size by removing larger particles, increase the average particle size by removing smaller particles, or cause the carbon precursor to exhibit a more uniform particle size.

The average particle size of the carbon precursor may be selected based on the desired properties of the carbon form. In an example, a carbon precursor exhibiting a relatively larger particle size may form a carbon foam exhibiting a larger average pore size than a carbon source exhibiting a relatively smaller particle size. The average pore size of the carbon precursor may affect the strength and density of the carbon foam. In an example, the carbon precursor may exhibit a single mode particle size or a bimodal or greater particle size. The carbon precursor exhibiting a single mode particle size may exhibit a single average particle size. The carbon precursor exhibiting a bimodal or greater particle size may include a first carbon precursor exhibiting a first average particle size and a second carbon precursor exhibiting a second average particle size that is different and distinguishable (e.g., at least about 10% larger, at least about 25% larger, at least 50% larger, or at least 100% larger) from the first average particle size. The carbon precursor exhibiting a single mode particle size may exhibit a porosity (e.g., average pore size and/or percent void space) that is greater than and a density that is less than the carbon precursor exhibiting bimodal or greater particle size.

During and/or after act 115, the method 100 may also include an act 116 of collecting the extracted portion. In some embodiments, the extracted portion can be further processed to produce at least one other carbon material as shown by act 118 of method 100. In act 118, the at least one other carbon material can include at least one of a pitch, a graphene, a carbon fiber, or a combination thereof.

After act 115, the method can include act 120 of heating the carbon foam precursor at atmospheric pressure to form the carbon foam. In some embodiments, act 120 may include heating the carbon foam temperature to about 300° C. or greater, about 350° C. or greater, about 400° C. or greater, about 450° C. or greater, about 500° C. or greater, or in ranges of about 300° C. to about 400° C., about 350° C. to about 450° C., or about 400° C. to about 500° C. The final temperature may be about 400° C. or greater, about 450° C. or greater, about 500° C. or greater, about 550° C. or greater, about 600° C. or greater, about 700° C. or greater, or in ranges of about 400° C. to about 500° C., about 450° C. to about 550° C., about 500° C. to about 600° C., or about 550° C. to about 700° C. The carbon foam precursor may be in a container or vessel configured to shape the foam and control heat up rate. The container may be heated at a selected rate. The at least one rate may be about 0.25° C. per minute (“° C./min”) or greater, about 0.5° C./min or greater, about 1° C./min or greater, about 1.5° C./min or greater, about 2° C./min or greater, about 3° C./min or greater, about 4° C./min or greater, about 5° C./min or greater, about 7.5° C./min or greater, about 10° C./min or greater, about 15° C./min or greater, about 20° C./min or greater, about 30° C./min or greater, about 40° C./min or greater, about 50° C./min or in ranges of about 0.25° C./min to about 1° C./min, about 0.5° C./min to about 1.5° C./min, about 1° C./min to about 2° C./min, about 1.5° C./min to about 3° C./min, about 2° C./min to about 4° C./min, about 3° C./min to about 5° C./min, about 4° C./min to about 7.5° C./min, about 5° C./min to about 10° C./min, about 7.5° C./min to about 15° C./min, about 10° C./min to about 20° C./min, about 15° C./min to about 30° C./min, about 20° C./min to about 40° C./min, about 30° C./min to about 50° C./min. The rate may be selected based on the composition of the carbon source, the solvent used, the amount of the carbon source in the mixture, the desired porosity of the carbon foam, the insulating properties of the green carbon foam, or the rate that allows a consistent heat gradient in the mixture, etc.

In an embodiment, act 120 may include heating the carbon foam precursor at a plurality of rates. For example, the container may be heated at a first rate to a first temperature followed by heating the container at a second rate to a second temperature. Generally, the first rate is greater than the second rate since causing the mixture to foam may increase the thermal insulating properties thereof thereby requiring a lower rate to maintain a consistent heat gradient in the mixture. In other words, the decrease in heating rate is attributed to creating a consistent heat gradient and therefore more consistent and stronger solid carbon foam. In a particular non-limiting example, the container may be heated at the first rate (e.g., about 2° C./min to about 50° C./min) until the container reaches a temperature of about 200° C. to about 350° C., such as about 250° C. to about 300° C. Then, the container is heated at the second rate (e.g., about 0.25° C./min to about 15° C./min) until the green carbon foam is formed. In an embodiment, the heating of the carbon foam precursor may require adjusting the heating rate at least once due to maintaining an even temperature gradient as a carbon foam becomes more insulating as it forms. It is noted that act 120 may be performed at atmospheric pressure and/or in a non-oxidizing atmosphere.

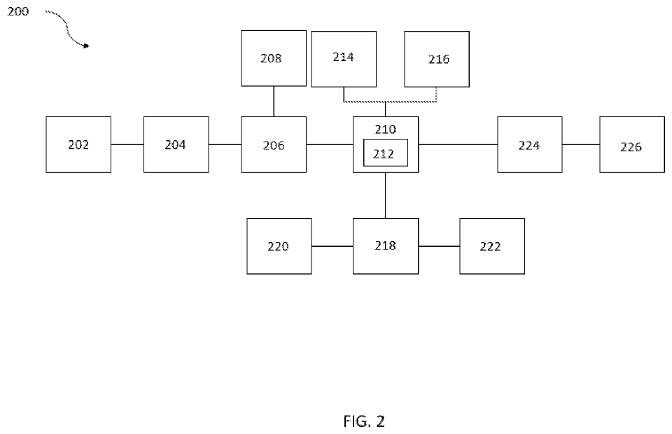

During act 120 of heating the carbon foam precursor, act 122 of the extracted portion described above forms a protective layer on an exterior surface of the carbon foam. In some embodiments, a carbon foam includes a solid porous carbon, a carbon fiber or carbon fiber tow incorporated within the porous carbon (described below with reference to FIG. 2), and a protective coating disposed on an outer surface of the carbon foam. In act 122, the protective coating is formed by applying a volatile rich component to an interior surface of the container holding the carbon fiber precursor. In some embodiments, act 122 may include manipulating the volatile content of the carbon foam precursor during the solvent extraction process. In other embodiments, act 122 may include a combination of applying the volatile rich component to an interior surface of the container and manipulating the volatile content of the carbon foam precursor during the solvent extraction process. In some embodiments, during act 120, act 124 of adding a pitch to the container may be include in the method 100. The pitch can form a protective layer on an exterior surface of the carbon foam, similar to the extracted portion. Because the volatiles are being removed during the partial solvent extraction act 106, pitch may be added in act 124 to provide the benefit of the protective layer.

In an embodiment, the protective layer may include a graphene, graphene oxide, graphite, a foam of non-porous carbon, or a combination thereof. The layer may form on at least a portion of the carbon foam. The protective layer may include a protective coating that remedies at least some of the above noted deficiencies of carbon foam. For example, heating the carbon source (e.g., coal or coal extracted materials) and/or carbon foam precursor in a container under a non-oxidizing environment, for example during acts 106 and 120, graphene, graphene oxide, or graphite can be produced along with the desired solid carbon foam. Under these conditions, the graphene, graphene oxide, or graphite tends to collect in a layer along the outside of the carbon foam at the interface with the container. The result is a porous solid carbon foam that has a skin or outer layer of graphene oxide. Since both forms of carbon were derived from the same starting material, the coefficients of thermal expansion are such that the bond between the porous carbon and graphing oxide remains intact or is even strengthened during further processes of calcination in act 126 and graphitization in act 128.

The volatile content of the carbon source (e.g., coal, coal derived pitch, or petroleum derived pitch) and/or the solvent used is the main factor in determining if a protective layer will be deposited and if so, the thickness and quality of the layer. The availability of the proper concentration of volatile material under the proper heating conditions allow the volatile material to convert into a sp2-hybridized form of carbon. The greater the volatile content of the carbon source and/or the mixture, the greater the amount of graphene and/or graphene oxide produced on the outside of the carbon foam. This is especially apparent when producing carbon foams and cokes from pitches.

The protective layer formed in situ on the carbon foam may exhibit a thickness that is about 10 nm or greater, about 50 nm or greater, about 100 nm or greater, about 250 nm or greater, about 500 nm or greater, about 750 nm or greater, about 1μm or greater, about 5μm or greater, about 10 μm or greater, about 25 μm or greater, about 50 μm or greater, about 100 μm or greater, about 250 μm or greater, about 500 μm or greater, about 750 μm or greater, about 1 mm or greater, or in ranges of about 50 nm to about 250 nm, about 100 nm to about 500 nm, about 250 nm to about 750 nm, about 500 nm to about 1 μm, about 750 nm to about 2.5 μm, about 1 μm to about 5 μm, about 2.5 μm to about 7.5 μm, about 5 μm to about 10 μm, about 7.5 μm to about 25 μm, about 10 μm to about 50 μm, about 25 μm to about 75 μm, about 50 μm to about 100 μm, about 75 μm to about 250 μm, about 100 μm to about 500 μm, about 250 μm to about 750 μm, or about 500 μm to about 1 mm. The graphite layer, when produced, includes a maximum thickness of about 1-2 cm.

One of the drawbacks of using carbon foam as a building material is the surface of the finished product. The surface of carbon foam has a rough texture and can cause injuries if brushed up against. Another drawback of carbon foams is the durability of an exposed carbon foam surface over time. With continual wear, particles of the carbon foam will eventually begin to break off from the structure. In order to be a viable building material, the carbon foam must have a protective coating applied. Currently, reliable technology does not yet exist for an economically feasible protective carbon foam coating which can withstand similar conditions with a similar coefficient of thermal expansion to take advantage of the properties of the carbon foam. Furthermore, a protective coating would only add to the already high cost of producing carbon foam using standard methods.

After act 120, the method 100 may include act 126. Act 126 includes a calcination process where the carbon foam formed during act 120 is heated to about 800° C. to about 1400° C. (e.g., about 800° C. to about 1000° C., about 900° C. to about 1200° C., or about 1100° C. to about 1400° C.) to further drive off volatiles and continue cross-linking produce a stronger solid carbon foam with a greater percentage of carbon. This act also has a long residence time due to the insulating nature of the foam and the susceptibility of the material to crack if it is inconsistently heated. It is noted that act 126 may be performed at atmospheric pressure and/or in a non-oxidizing atmosphere, though this is not required.

After act 126, the method 100 may include act 128. Act 128 includes graphitization. Graphitization is when the carbon foam is taken to a temperature of 2000° C. to about 2600° C., such as about 2500° C., where nearly all of the remaining volatiles are driven off leaving a pure carbon material. This act 128 is usually taken for carbon foams where high heat transfer is desired. These carbon foams are normally used to dissipate and/or conduct heat while being able to withstand very harsh environments. It is noted that the graphitization act may be performed at atmospheric pressure and/or in a non-oxidizing atmosphere, though this is not required.

In some embodiments, the method 100 includes act 130 of producing a finalized carbon foam. Note that acts 126 and act 128 are not required in the method 100, but may be desired to achieve predetermined characteristics in the carbon foam.

FIG. 2 is a schematic illustration of a system 200 that may perform the method 100, according to an embodiment. The system 200 includes at least one carbon source reservoir 202 coupled to and configured to provide the carbon source to at least one particle size apparatus 204. For example, the carbon source reservoir 202 may include an outlet that is coupled to an inlet of the particle size reduction apparatus 204. The particle size apparatus 204 may include any apparatus that is configured to at least one of reduce, control, or select the particle size of the carbon source. For example, the particle size apparatus 204 may include a grinding apparatus, a milling apparatus, a crusher, a homogenization apparatus, a sieving apparatus, or any other suitable apparatus. In the illustrated embodiment, the system 200 only includes a single particle size apparatus though, it is noted, the system 200 may include a plurality of particle size apparatuses, such as a grinding apparatus and a sieving apparatus. It is noted that the particle size apparatus may be omitted from the system 200, such as when the carbon source provided from the carbon source reservoir 202 already exhibits a desired size.

The particle size apparatus 204 (or the carbon source reservoir 202 if the particle size apparatus 204 is omitted) is configured to provide the carbon source to the blending apparatus 206. For example, the particle size apparatus 204 may include an outlet that is coupled to an inlet of the blending apparatus 206. The system 200 also includes a solvent reservoir 208 that is configured to provide at least one solvent to the blending apparatus 206. For example, the solvent reservoir 208 may include an outlet that is coupled to an inlet (the same inlet or a different inlet that received the carbon source) of the blending apparatus 206. The blending apparatus 206 is configured to blend the carbon source and the solvent together to form the mixture. As such, the blending apparatus 206 may include a chamber that is configured to hold the carbon source and the solvent and, optionally, a mixer that is configured to blend the carbon source with the solvent. The mixer may include any suitable mixer, such as a mechanical mixer or an ultrasound transducer.

The blending apparatus 206 is configured to provide the mixture to a furnace 210. For example, the blender 206 may include an outlet and the furnace 210 may include in inlet. The furnace 210 may include a container that is configured to receive the mixture. The furnace 210 may be configured to heat the container to a selected temperature at one or more selected rates. In the illustrated embodiment, the system 200 includes a single furnace 210 that is configured to perform acts 110 and 112 of the method 100. However, it is noted that the system 200 may include two or more furnaces that perform different portions of acts 110 and 112. The furnace 210 may also include a continuous belt 212 that allows the method 100 to be a continuous process, as previously discussed.

The system 200 may include an inert gas reservoir 214 that is configured to provide at least one inert gas to the furnace 210 thereby allowing the mixture to be heated in a non-oxidizing atmosphere. The system 200 may also include a carbon fiber source 216 that is configured to provide carbon fiber to the furnace 210. The system 200 may also include a solvent and liquid recovery apparatus 218 that is configured to receive solvent and liquid from the furnace 210, as previously discussed herein. The solvent and liquid recovery apparatus 218 may be configured to provide the solvent and liquid recovered thereby to a solvent reservoir 220 and a liquid reservoir 222, respectively. It is noted that the solvent reservoir 220 may be distinct from, in fluid communication with, or the same as the solvent reservoir 208.

The system 200 may include a calcination furnace 224 that is configured to receive carbon foam from the furnace 210 and calcinate the carbon foam. In an embodiment, as illustrated, the calcination furnace 224 is distinct from the furnace 210. However, it is noted that the calcination furnace 224 may be integrally formed with the furnace 210.

The system 200 may also include a graphitization furnace 226 that is configured to receive carbon foam from the calcination furnace 224 and graphitize the carbon foam. In an embodiment, as illustrated, the graphitization furnace 226 is distinct from the furnace 210 and the calcination furnace 224. However, it is noted that the graphitization furnace 226 may be integrally formed with at least one of the furnace 210 or the calcination furnace 224.

Further, graphitic carbon foams with highly aligned crystallites in the ligaments have been shown to have many high value and performance enabling applications. Processing of coal or other mesophase forming carbon precursor product to form the anisotropic phase of pitch solution is shown in step one. In step two, the pitch solution can be optimized with anisotropic to isotropic ratios and volatile contents by partial solvent extractions. In some examples, these processes can be carried out in a vertically integrated processing facility. The processes and optimized pitch solutions can be provided into an extruder whereupon it can be formed into any of the carbon products described herein, such as carbon foams, composite materials including carbon foams, graphene oxide, and/or carbon materials including graphene oxide formed or coated thereon.

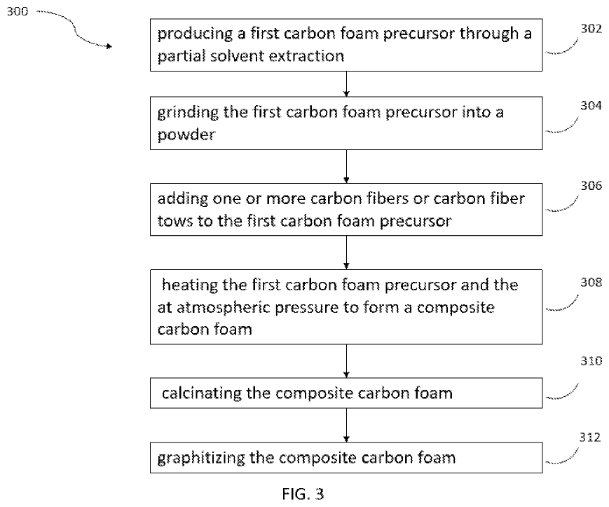

FIG. 3 is a flow chart of a method 300 to form a composite carbon foam, according to an embodiment. In some embodiments, the carbon foam can include a solid porous carbon, a carbon fiber or carbon fiber tow incorporated within the porous carbon, and a protective coating disposed on an outer surface of the carbon foam. As described with respect to method 100, the protective coating may be formed by applying a volatile rich component to an interior surface of a container holding a precursor to the carbon foam, manipulating the volatile content of the precursor to the carbon foam during the solvent extraction processor, or a combination thereof. In some embodiments, the protective coating includes a graphene, a graphene oxide, a foam of non-porous carbon, or a combination thereof.

The method 300 may include act 302. Act 302 includes producing a first carbon foam precursor through a partial solvent extraction similar or the same as act 106 described above. In some embodiments, however, the carbon foam can be produced from two or more precursors to the carbon foam. In some embodiments, a portion of the carbon foam can be produced from a first precursor and another portion of the carbon foam can be produced from the second precursor. In some embodiments, a third or more precursor may be included to produce the carbon foam. In some embodiments, the carbon foam produced from the first precursor can exhibit characteristics different from a portion of the carbon foam produced from the second precursor. In some embodiments, a carbon foam produced from a third precursor may include characteristics different from the portion of the carbon foam produced by the first and/or second precursor. In some embodiments, the characteristics can include at least one of heat transferability, strength, weight, or electrical conductivity. The method 300 may include act 304. Act 304 includes grinding the first carbon foam precursor into a powder similar or the same as act 115 described above. In some embodiments, the powered includes an average particle size of about 50 nm or greater.

The method 300 further includes act 306. Act 306 includes adding one or more carbon fibers and/or carbon fiber tows to the first carbon foam precursor. The carbon fiber and/or carbon fiber tows can include a green carbon fiber, a calcinated carbon fiber, or a carbon fiber that is heat treated to be an intermediate between the green carbon fiber and calcinated carbon fiber. Adding the carbon fibers to the carbon foams may allow the thermal properties and the strength of the carbon foam to be controllably modified. For example, the carbon foam composite can be produced in a continuous process by running a feedstock of the carbon fibers through a furnace with increasing temperature. Using a method such as this, the carbon fibers can be drawn across the surface of the carbon foam in the same direction as the heating process while a second layer of material (e.g., an addition carbon foam, an additional precursor, an additional quantity of the mixture, and/or an additional layer of carbon fibers) is placed on top of the carbon fibers. Thus, the carbon foam would form around the carbon fiber with the carbon fiber acting as a rebar to strengthen the solid carbon foam composite.

Unlike conventional carbon foams, the method 300 allows the production of carbon foam via a partial solvent extraction with the carbon fiber rebar. In an example, the carbon foam is produced through a sintering process where the carbon source is fused together as opposed to traditional foaming methods of where the carbon source actually foams as the size of the material increases vertically. The method of sintered particles to create the foam allows for the carbon fiber to stay intact throughout the foaming process. In an example, at least a portion of the method 300 can be made into a true continuous process. For instance, at least acts 304 and 306 may be made into a continuous process since these acts are where the solid carbon skeleton of the carbon foam is formed. Under traditional methods of producing carbon foam, the ground coal is placed in a container or mold and subjected to increasing temperatures under pressure in an inert environment. Given the nature of the coal powder, the mold, and the harsh conditions inside of the autoclave where the foaming takes place, it is not feasible to stretch carbon fibers in the center of a piece of carbon foam as is being formed. However, in a process where the carbon foam is being formed as it progresses through a system on a continuous belt, the carbon fibers can be incorporated in to the composite material and can continue to be fed as the carbon foam production proceeds. In an example, the atmospheric pressure conditions in the partial solvent extraction and green foam process steps allows the carbon fiber to be disposed within the carbon foam. Most traditional green carbon foam production methods require pressure. During the method 300, the partial solvent extraction method allows act 302 at atmospheric pressure allowing for a continuous process. It also allows for the carbon fiber to be introduced to the mixture whereas it would not be possible with a system under pressure. Act 306 can further include drawing the one or more carbon fibers across a surface of the carbon foam precursor and then adding an additional carbon foam precursor to incorporate the carbon fiber or carbon fiber tows within the composite carbon foam. In some embodiments, the additional carbon foam precursor includes a second carbon foam precursor. The second carbon foam precursor is different from the first carbon foam precursor, such that the composite carbon foam includes physical characteristics that interface at the carbon fiber or carbon fiber tow. In some embodiments, the act 306 of adding one or more carbon fibers or carbon fiber tows includes applying a tension to the one or more carbon fibers or carbon fiber tows. The tension is configured to compensate for thermal expansion of the porous carbon and the carbon fiber. The tension may be applied prior to act 306 in some embodiments.

The method 300 further includes act 308. Act 308 includes heating the first and/or second carbon foam precursor and the one or more carbon fibers and/or carbon fiber tows at atmospheric pressure to form a composite carbon foam. In some embodiments, the first and/or second carbon foam precursor and the one or more carbon fibers and/or carbon fiber tows are heated in a non-oxidizing environment. The method 300 can further include act 310. In act 310, the composite carbon foam is calcinated. Calcinating the composite carbon foam includes heating the composite carbon foam to a temperature from about 800° C. to about 1400° C. In some embodiments, the method 300 can further include act 312. In act 312, the composite carbon foam is graphitized. The composite carbon foam can be graphitized by heating the composite carbon foam to a temperature from about 2000° C. to about 2600° C. Calcinating and graphitizing the coal drives of any remaining volatile compounds.

In some embodiments, the coefficient of thermal expansion of the porous carbon is about the same as the coefficient of thermal expansion of the carbon fiber and/or carbon fiber tow. By matching the coefficients of thermal expansion for the carbon foam produced in the carbon fibers, the composite carbon foam can then proceed through the calcination step 310 and/or graphitization step 312 with the overall composite material intact. As additional volatiles are driven off in the carbon material cross-links, the volume is decreased. By controlling the calcination conditions and choosing the correct input materials, the carbon fiber composite foam should reduce in volume at a favorable rate to maintain strength and other properties of the final product.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or +2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A method to form a carbon foam, the method comprising:
providing a carbon source;
blending the carbon source with a solvent to form a mixture;
heating the mixture at atmospheric pressure and in a non-oxidizing atmosphere to produce a carbon foam precursor and a solvent mixture with extracted volatiles; and
heating the precursor at atmospheric pressure to form a carbon foam.

2. The method of claim 1, further comprising a partial solvent extraction, wherein the partial solvent extraction includes transferring the carbon foam precursor to a container and heating the mixture disposed within the container to an intermediate temperature in a non-oxidizing atmosphere.

3. The method of claim 1, further comprising separating the extracted volatiles from the carbon source from the solvent and further processing the extracted volatilies into carbon materials.

4. The method of claim 1, further comprising calcinating the carbon foam;
wherein calcinating the carbon foam comprises heating the carbon foam to a temperature from about 800° C. to about 1400° C.

5. The method of claim 1, further comprising graphitizing the carbon foam;
wherein graphitizing the carbon foam comprises heating the carbon foam to a temperature from about 2000° C. to about 2600° C.

6. The method of claim 1, wherein the carbon source includes at least one of a bituminous coal, sub-bituminous coal, pitch derived from sub-bituminous coal, a lignite coal, a pitch derived from lignite coal, coal tar, recycled green foam, and a green coke.

7. The method of claim 1, wherein providing at least one carbon source comprises grinding the carbon source to an average particle size of between about 1 cm to about 50 nm.

8. The method of claim 7, wherein grinding the carbon source comprises producing a bimodal particle size comprising a first average particle size and a second average particle size, wherein the second average particle size is different from the first average particle size.

9. The method of claim 8, wherein grinding the carbon source comprises producing a bimodal particle size comprising a first carbon source and a second carbon source, wherein the second carbon source includes an average particle size that is different from the first carbon source.

10. The method of claim 1, wherein the solvent comprises a polar solvent, a non-polar solvent, an organic solvent, an inorganic solvent, a supercritical solvent, a critical solvent, a subcritical solvent, or a combination thereof.

11. A method to form a composite carbon foam, the method comprising:
producing a first carbon foam precursor from a mixture that includes a carbon source and a solvent;
grinding the first carbon foam precursor into a powder, wherein the powder includes an average particle size of at least about 50 nm;
adding a carbon fiber or carbon fiber tows to the first carbon foam precursor; and
heating the first carbon foam precursor and the carbon fiber or carbon fiber tows at atmospheric pressure to form a composite carbon foam.

12. The method of claim 11, wherein adding carbon fiber or carbon fiber tows to the first carbon foam precursor comprises drawing the carbon fiber across a surface of the carbon foam precursor and then adding an additional carbon foam precursor to incorporate the carbon fiber or carbon fiber tows within the composite carbon foam.

13. The method of claim 12, wherein the additional carbon foam precursor includes a second carbon foam precursor, wherein the second carbon foam precursor is different than the first carbon foam precursor.

14. The method of claim 11, further comprising calcinating the composite carbon foam, wherein calcinating the composite carbon foam comprises heating the composite carbon foam to a temperature from about 800° C. to about 1400° C.

15. The method of claim 11, further comprising graphitizing the composite carbon foam, wherein graphitizing the composite carbon foam comprises heating the composite carbon foam to a temperature from about 2000° C. to about 2600° C.

16. The method of claim 11, wherein the first carbon foam precursor is heated in a non-oxidizing atmosphere.

17. A composite carbon foam, comprising a carbon foam disposed within a graphene, a graphene oxide, or a graphite outer layer.

18. The composite carbon foam of claim 17, wherein the graphene, graphene oxide, or graphite outer layer includes a thickness of at least about 10 nm.

19. The method of claim 17, wherein the characteristics of the outer layer are controlled by the type of material in an outer layer disposal process environment.

20. The composite carbon foam of claim 16, further comprising a carbon fiber or a carbon fiber tow incorporated within the solid porous carbon foam.

21. The composite carbon foam of claim 16, wherein the protective coating is formed by applying a volatile rich component to an interior surface of a container holding a precursor to the carbon foam, manipulating the volatile content of the precursor to the carbon foam during the solvent extraction processor, or a combination thereof.

22. The composite carbon foam of claim 16, wherein the composite carbon foam includes highly aligned crystallites in the ligaments.
